(19) United States
(12) Patent Application Publication
(10) Pub. No.: US 2004/0157092 A1
(43) Pub. Date: Aug. 12, 2004

(54) Polygonal fuel cell

(76) Inventors: Serge Kimberg, Toronto (CA); Alexander Gofer, Toronto (CA); Miklosh Rubin, Richmond Hill (CA)

Correspondence Address: Boris Parad, Parad Law Offices, P.C., Suite 705, 4711 Golf Road, Skokie, IL, 60076, US

(21) Appl. No.: 10/361,996

(22) Filed: Feb. 7, 2003

(51) Int. Cl. H01M 8/00

(52) U.S. Cl. 429/12

(57) ABSTRACT

A polygonal electrochemical fuel cell comprises an outer film screen, independent channels conducting air and water, a reactant gas chamber defined by a corrugated multi-prong and multi-layered wall. The outer film screen attached to the rounded chamber wall prongs, which are equidistantly and circumferentially positioned on said chamber wall, defines polygons of the cell.

The curvilinear chamber wall provides a compact, structurally strong, lightweight and inexpensive cell design increasing the current working surface area and respective current output by 40% in comparison with the analogous tubular cell design. The cell polygons allow a substantially gap-free attachment of the adjacent cells to form modules of various shapes and without bulky edge and bipolar plates, gaskets, screws and other connectors present in traditional cells. The multi-functional gas chamber wall serves as a cell frame, water drain conduit, pressurized gas container and electric current connector.

### BACKGROUND OF THE INVENTION

This invention relates to electrochemical fuel cells and more particularly to their most efficient and compact structural designs for generating electric current. The prior art is replete with hydrogen fuel assemblies for passing a hydrogen-containing gas through the electrolyte member and reacting with the oxygen atoms to form water and generate an electrical current in the anode and cathode system. For example, U.S. Pat. No. 5,509,942 by Dodge disclosed a hydrogen fuel cell utilizing with a plurality of layers of planar members, such as a layered porous anodic electrode, a solid electrolyte and a layered porous cathodic electrode exposable to oxygen, to form tubular and frusto-conical cells with concentrical layers. Connectors, screws, plates and links join the tubular cells to form a cell battery.

U.S. Pat. No. 6,063,517 by Montemayor teaches a spiral wrapped cylindrical proton exchange membrane cell including a planar anode ionically communicating with a catalyst and a sleeve defining a hydrogen flow path. U.S. Pat. No. 6,007,932 by Steyn discloses a tubular fuel cell with a porous tubular substrate and a plurality of flexible polymer electrolyte fuel cells wound in side-by-side relation onto the substrate. U.S. Pat. No. 5,458,989 by Dodge discloses a tubular fuel cell and utilizing hydrogen-containing connectors, frames and batteries or banks of parallel mounted fuel cells. U.S. Pat. No. 6,001,500 by Bass discloses a cylindrical fuel cell and a method of its manufacturing.

A typical fuel cell provides for supply of the reactants, such as hydrogen and oxygen, transportation of water and inert gases (nitrogen and carbon dioxide from air), and electrodes to support a catalyst, collect electrical charge, and dissipate heat. Such a cell usually has cathodic and anodic electrodes and an electrolyte sandwiched between them. Fuel cells use ion transfer thorough the membrane- to produce electrochemical reactions between the reactants (hydrogen gas at the anode and oxygen from ambient air at the cathode), which are supplied from each electrode side of the membrane from an external tank or other source. An ambient air forced to flow through the fiber cathode electrode and react with the catalyst layer of the cathode electrode to cause a chemical reaction for production of current and water. Besides electrical and thermal resistance, reactant pressures and temperatures, the surface area and geometry of the cell structure are the main factors affecting the performance, occupied space and efficiency.

None of the prior art references known to the inventor discloses the present invention shown and described herein.

### SUMMARY OF THE INVENTION

A novel polygonal electrochemical fuel cell comprising a plurality of independent gas channels circumferentially located about the reactant gas chamber. The corrugated multi-layered chamber wall with the rounded equidistant prongs and an outer film screen wrapped around the circumferentially positioned prongs form the gas channels. The screen shell attached to the prongs defines the cell polygons. The corrugated wall structure and polygonal shape of the cell provide for a rigid, compact, light and inexpensive structure, and the increased electric current production surface with the respective direct current output. The polygonal cells may be joined together along their polygons in a substantially gap-free arrangement without screws, links or other structural support in various modular combinations.

The unique compact design reduces a cross-sectional area or footprint of the cell and increases its output, while allowing a gap-free and connector free union of the cells in any space-fitting pattern.

### BRIEF DESCRIPTION OF THE DRAWINGS

FIG. 1 is a schematic longitudinal cross-sectional view of a fuel cell.

FIG. 2 is a schematic lateral cross-sectional view of the fuel cell showing the chamber prongs and gas channels.

FIG. 3 is a partial lateral cross-sectional view of the fuel cell showing the channel wall details.

FIG. 4 is a schematic lateral cross-sectional view of one embodiment of a fuel cell bank.

FIG. 5 is a schematic lateral cross-sectional view of another embodiment of the fuel cell assembly.

### DESCRIPTION OF THE INVENTION

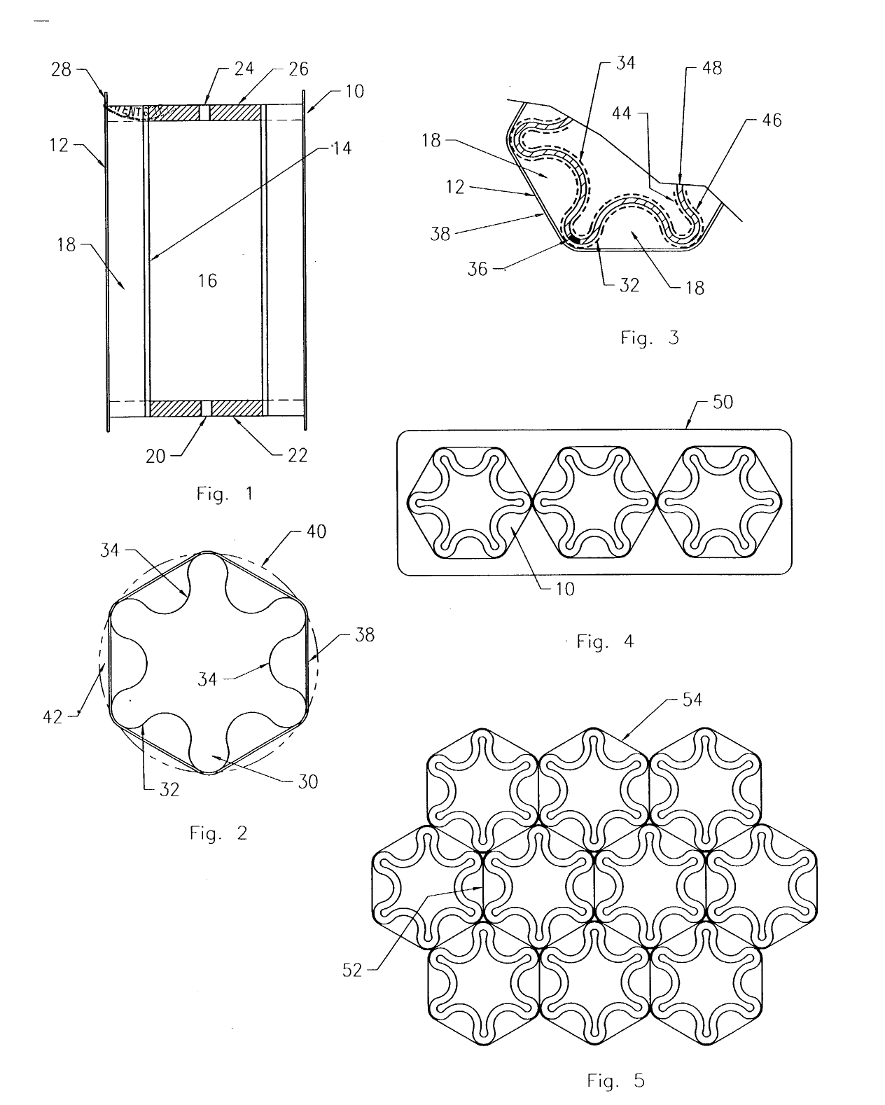

As shown in FIG. 1, a polygonal fuel cell 10 comprises an outer screen shell 12 wrapped around a multi-layered corrugated gas chamber wall 14, which separates the gas chamber 16 from the longitudinal channels 18. The wall channels 18 contain one type of reactant gas, such as oxygen or air, and the chamber contains another type of reactant gas, such as hydrogen. Active reactant gas enters the chamber 16 through the inlet opening 20 in the chamber bottom plate 22 and exits through the outlet opening 24 in the chamber top plate 26. The outer shell 12 may be made from a thin, dielectric, air permeable, and waterproof film screen. The foldable outer screen extension 28 protrudes beyond the top and bottom plate levels in order to eliminate possible shortcuts between the adjacent cells in a stack.

The corrugated chamber wall 14 comprises a number of equidistantly spaced rounded prongs 30. The convex wall segments 32 merge with the wall concave segments 34. The corrugated wall edges are glued together at the longitudinal side seam 36 as shown in FIG. 3. The screen shell 12 covering the wall convex parts 32 defines the cell's polygon shape, such as an octagon, hexagon and so forth. Each polygon or side 38 spans the space between the nearest prong convex tips. The channel or chamber wall 14 constitutes a multi-angled secant with rounded angle ends or prongs 30. The rounded prongs 30 are equidistantly located about the chamber's periphery.

The polygonal shape of the shell creates a smaller “footprint” than the than the respective tubular shape 40 by the area of truncated sections 42. This area reduction minimizes the cell containing space, which is one of the advantages of the subject invention. Another advantage is that the working surface of the curvilinear chamber wall 12, combining its convex parts 32 and concave parts 34, greatly exceeds a cylindrical or tubular shape of the existing fuel cells.

The outer shell is glued or otherwise rigidly affixed to these prongs. The chamber wall 14 serves a dual function of a structural frame of the cell and current producing element. As shown in FIG. 3, the wall 14 comprises an inside current collector mesh 44 separated from the outer current collector screen 46 by an active element or electrode 48. The wall edge connection by the seal 36 contributes to the lightweight structure of the novel fuel cells.

As shown in FIG. 4, fuel cells may be combined in rows in order to fit a planar battery 50. Air or equivalent reactant gas may be caused to flow through natural convection as exemplified in the standalone linear cell bank shown in FIG. 4. In this embodiment, the cells 10 could be secured to each other within the canister (bank) or be free standing. In this case, the air flows normally to the lateral area of active element of the chamber wall.

The air may be supplied via forced convection to the cell assembly as shown in another embodiment of the cell package (cells contacting one another by the faces of the polygon) in FIG. 5. The air is propelled through the channels along the cell's longitudinal axis. The fuel cells may be glued or otherwise united to each other in numerous fitting patterns of tightly abutting cell polygons 52, without screws or other kind of connectors, to build cell modules 54 as shown in FIG. 5. The substantially connector-free and gap-free cell connection provides the cell space saving and facilitates cell package patterns, which could fit any angular, multi-prong, corner or circular space. The fuel cells may also be joined or stacked along their longitudinal axis for a desired length of the cell line.

An output of electric current generated by a chemical reaction between the gases and the channel wall material exceeds the known tubular fuel cell outputs due to the increased current-producing surface. This translates into a gain in the lateral area-to-volume ratio, which is the ratio of the length of the secant to the area of the cross section. The subject design increases the secant-to-area ratio by more than 40% in comparison to an equivalent circle.

Water generated during the fuel cell work and accumulated in the channels is drained either by gravitation (e.g. in breathing bank embodiment shown in FIG. 4) or pressurized airflow (applicable to the cell assembly embodiment illustrated in FIG. 5) without danger of shortcuts between the adjacent cells. A star (“snowflake”) cross-sectional design enhances the fuel cell gravimetric and volumetric power through the increased surface-to-volume ratio and the cell's simplified geometric design. A plurality of independent channels circumferentially located within the cell “occupy” the chamber space without any negative effect on the gas supply through the chamber.

The subject cell design eliminates drawbacks of cylindrical and flat plate assemblies, which utilize bulky bipolar plates, frames, massive screws and other connectors. The curvilinear shape of the wall adds to the wall's structural strength and rigidity in comparison to the straight beam-like plate. The novel cell is significantly lighter and cheaper than comparable existing devices due to elimination of graphite plates, cooling plates, end plates, massive rods, Teflon gaskets and other elements of traditional fuel cell supporting structures. The chamber wall provides a frame and structural support for the cell and for the module of cells being joined together for combined current output.

The cell construction lends itself to unlimited modular cell combinations of various shapes and sizes. The cell frame structure allows the substantially gap-free and connector-free cell stacking in lateral and longitudinal directions. Cooling, mass transfer management and maintenance functions become easier and simpler than the same in traditional devices.

Although the present invention has been described with reference to a preferred embodiment, it will be understood by those skilled in the art that numerous changes, omissions and additions may be made without departing from the spirit and scope of the subject invention.

We claim:

1. A polygonal electrochemical fuel cell comprising:
An outer shell encompassing a corrugated chamber wall of the gas-passing chamber;
Said shell and said chamber wall defining a plurality of independent gas channels;
Said channels located outside and about said chamber wall;
Said chamber wall comprising layers of current collector and electrode elements.

2. The polygonal electrochemical fuel cell of claim 1, and further comprising:
Said chamber wall comprising a plurality of prongs;
Said outer shell being wrapped around said prongs;
A plurality of cell polygons being formed by the shell sections spanning said prongs.

3. The polygonal electrochemical fuel cell of claim 1, and further comprising:
Said chamber including an inlet and outlet openings for the reactant gas passing through the top and bottom ends of said chamber; and
Said outer shell being made of air permeable and waterproof material.

4. The polygonal electrochemical fuel cell of claim 1, and further comprising:
Said chamber wall edges being sealed together to form a longitudinal side seam along the cell.

5. The polygonal electrochemical fuel cell of claim 1, and further comprising:
Said chamber wall providing a structural support for said cell and producing electric current as a result of chemical reaction of reactant gases passing through said wall.

6. The polygonal electrochemical fuel cell of claim 1, and further comprising:
Said independent channels circumferentially located around said gas chamber;
Said chamber wall layers including an inner current collector mesh, outer current collector mesh and an electrode means.

7. The polygonal electrochemical fuel cell of claim 1, and further comprising:
Said chamber wall prongs being rigidly secured to the outer shell;
Said prongs equidistantly positioned about said chamber.

8. The polygonal electrochemical fuel cell of claim 1, and further comprising:
Said chamber including an inlet and outlet openings for the reactant gas passing through the top and bottom ends of said chamber;
Said outer shell being made of air permeable and waterproof material;
Said wall forming a frame structure providing lateral and longitudinal rigidity for said cell.

9. The polygonal electrochemical fuel cell of claim 1, and further comprising:
Said channels being a conduit for draining the fluid produced as a result of electrochemical reaction between the gases passing through the chamber, chamber wall and said channels.

10. A polygonal electrochemical fuel cell comprising:
A reactant gas chamber comprising a corrugated multi-layered wall with a plurality of rounded prongs being enclosed by an outer screen;
Said prongs located about said wall;
Said wall and outer screen forming a series of longitudinal reactant gas channels;
Each of said channels being a conduit for draining water being produced as a result of a chemical reaction between the reactant gases flowing through the chamber, chamber wall and the chamber surrounding channels.

11. The polygonal electrochemical fuel cell of claim 10, and further comprising:
Said screen forming polygons bordered by said rounded prongs; and
Said screen being made from an air permeable and water-resistant material.

12. The polygonal electrochemical fuel cell of claim 10, and further comprising:
Said outer screen having a foldable extension protruding beyond the chamber wall.

13. The polygonal electrochemical fuel cell of claim 10, and further comprising:
Said chamber wall providing structural strength for the longitudinal and lateral stacking of the cells in a substantially gap-free and connector-free manner;
Said chamber wall being a part of air and water transportation conduit outside the gas chamber;
Said wall comprising a catalyst and current collector meshes;
Said gas chambers having an inlet and outlet openings in its top and bottom elements for passing the pressurized gas through the chamber; and
An outer shell extension protruding beyond said wall.

14. A polygonal electrochemical fuel cell assembly comprising:
A plurality of polygonal fuel cells abutting the polygons of one another in a substantially gap-free and connector-free manner;
Each of said cells comprising a corrugated multi-layered gas chamber wall;
Said wall providing a rigid frame structure for said cell;
Said wall being surrounded by a plurality of reactant gas channels within each cell; and
Said cells providing structural self-support for said assembly.
